(19) United States
(12) Patent Application Publication
(10) Pub. No.: US 2026/0237342 A1
(43) Pub. Date: Aug. 13, 2026

(54) GATE DRIVE UNIT AND DISPLAY DEVICE

(71) Applicant: Guangzhou China Star Optoelectronics Semiconductor Display Technology Co., Ltd., Guangzhou, Guangdong (CN)

(72) Inventors: DONGHUN LIM, Guangzhou, Guangdong (CN); Yunpeng LIN, Guangzhou, Guangdong (CN); Zelin YANG, Guangzhou, Guangdong (CN); Yingchun ZHAO, Guangzhou, Guangdong (CN); Qian ZHAO, Guangzhou, Guangdong (CN)

(21) Appl. No.: 18/571,274

(22) PCT Filed: Sep. 25, 2023
(86) PCT No.: PCT/CN2023/121270

§ 371 Date: Apr. 30, 2026

(30) Foreign Application Priority Data
Sep. 19, 2023 (CN) 202311215326.1

(51) Int. Cl. G09G 3/32; G09G 3/3266; G09G 3/36

(52) U.S. Cl. CPC G09G 3/32; G09G 3/3266; G09G 3/3677; G09G 2300/0819; G09G 2300/0842; G09G 2310/0267; G09G 2330/023

(57) ABSTRACT

The present disclosure provides a gate drive unit and a display device. A pull-up control module of the gate drive circuit of a current stage receives a gate control signal output from the gate drive circuit of a previous stage, so that a cascading module is omitted from the gate drive circuit, cascading control for the gate drive circuit of a plurality of stages may be realized, the number of transistors used in the gate drive circuit is reduced, and the layout space occupied by the gate drive circuit is reduced.

### TECHNICAL FIELD

The present disclosure relates to a display technology field, and more particularly, to a gate drive unit and a display device.

### BACKGROUND

A current gate drive unit usually uses fifteen thin film transistors to realize the function of outputting square wave pulse signals row by row, and thus occupies the larger layout space of the display panel, which is disadvantageous to the design of a narrow frame for the display panel. Further, the gate drive circuit in a small-sized display device occupies the layout space of the sub-pixels to a greater extent than the gate driver circuit, with the same topology as that of the small-sized display device, in the medium-sized or large-sized display device, thereby affecting the display effect of the small-sized display device.

### SUMMARY

An embodiment of the present invention provides a gate drive unit and a display device, which may improve a problem that a gate drive circuit occupies the larger layout space and is disadvantageous to the design of the narrow frame for the display panel, and the gate drive circuit has a serious problem that the gate driver circuit crowds the layout space of the sub-pixels when the gate drive circuit is applied to the small-size display device.

### Technical Solution

An embodiment of the present disclosure provides a gate drive unit including a plurality of cascaded gate drive circuits. At least one of the gate drive circuits includes a pull-up control module, a pull-up module, a pull-down maintenance module, and a pull-down module. The pull-up control module is electrically connected to the first node, and the pull-up control module is configured to receive the gate control signal output from the gate drive circuit of a previous stage and transmit a first power supply signal to the first node. The pull-up module is electrically connected to the first node, and the pull-up module is configured to transmit a first clock signal to a signal output terminal of the gate drive circuit of a current level according to a potential of the first node. The pull-down maintenance module is electrically connected to the first node, and the pull-down maintenance module is configured to transmit a second power supply signal to the first node according to a second clock signal and a third clock signal. The pull-down module is electrically connected to the first node, and the pull-down module is configured to transmit the second power supply signal to the first node according to a gate control signal output from a lower gate drive circuit.

Alternatively, in some embodiments of the present disclosure, the pull-up control module includes a pull-up control transistor, a control terminal of the pull-up control transistor is configured to receive the gate control signal output from the gate drive circuit of the previous stage, an input terminal of the pull-up control transistor is configured to receive the first power supply signal, and an output terminal of the pull-up control transistor is electrically connected to the first node.

Alternatively, in some embodiments of the present disclosure, the pull-up module includes a pull-up transistor and a storage capacitor, a control terminal of the pull-up transistor is electrically connected to the first node, an input terminal of the pull-up transistor is configured to receive the first clock signal, and an output terminal of the pull-up transistor is electrically connected to the signal output terminal of the gate drive circuit of the current level. The storage capacitor is connected in series with the control terminal of the pull-up transistor and the output terminal of the pull-up transistor.

Alternatively, in some embodiments of the present disclosure, the pull-down maintenance module includes a first transistor, a second transistor, a third transistor, a fourth transistor, a fifth transistor, and a sixth transistor. A control terminal of the first transistor is configured to receive the third clock signal, and an input terminal of the first transistor is configured to receive a third power supply signal. A control terminal of the second transistor is electrically connected to the first node, an output terminal of the second transistor is electrically connected to an output terminal of the first transistor, and an input terminal of the second transistor is configured to receive the second power supply signal. A control terminal of the third transistor is electrically connected to the output terminal of the first transistor, and an input terminal of the third transistor is configured to receive the third power supply signal. A control terminal of the fourth transistor is electrically connected to the first node, an input terminal of the fourth transistor is configured to receive the second power supply signal, and an output terminal of the fourth transistor is electrically connected to an output terminal of the third transistor. A control terminal of the fifth transistor is electrically connected to an output terminal of the third transistor, an input terminal of the fifth transistor is configured to receive the second power supply signal, and an output terminal of the fifth transistor is electrically connected to the first node. The control terminal of the sixth transistor is configured to receive the second clock signal, the input terminal of the sixth transistor is configured to receive the second power supply signal, and the output terminal of the sixth transistor is electrically connected to the control terminal of the fifth transistor.

Alternatively, in some embodiments of the present disclosure, the pull-down maintenance module further includes a seventh transistor having a control terminal configured to receive the second clock signal, an input terminal configured to receive the second power supply signal, and an output terminal electrically connected to the control terminal of the third transistor.

Alternatively, in some embodiments of the present disclosure, the pull-down maintenance module further comprises an eighth transistor having a control terminal electrically connected to the control terminal of the fifth transistor, an input terminal configured to receive the second power supply signal, and an output terminal electrically connected to the signal output terminal of the gate drive circuit of the current level.

Alternatively, in some embodiments of the present disclosure, the gate drive unit further includes a reset module including a reset transistor, a control terminal of the reset transistor configured to receive a reset control signal, an input terminal of the reset transistor configured to receive the third power supply signal, and an output terminal of the reset transistor electrically connected to the control terminal of the fifth transistor.

Alternatively, in some embodiments of the present disclosure, the pull-down module includes a pull-down transistor having a control terminal configured to receive the gate control signal output from the gate drive circuit of the next stage, an input terminal configured to receive the second power supply signal, and an output terminal configured to be electrically connected to the signal output terminal of the gate drive circuit of the current stage.

Alternatively, in some embodiments of the present disclosure, the pull-up control module of the gate drive circuit of an Nth stage receives the gate control signal output from the gate drive circuit of an (N−X)-th stage before the stage gate drive circuit of the Nth stage, and the pull-down module of the gate drive circuit of the Nth stage receives the gate control signal output from the gate drive circuit of an (N+Y)-th stage after the stage gate drive circuit of the Nth stage; and wherein Y>X, N>1, and X>0.

The present disclosure further provides a display device including a gate drive unit as described above and a plurality of sub-pixels. The plurality of sub-pixels are electrically connected to the plurality of gate drive circuits.

### Beneficial Effect

Compared with the prior art, an embodiment of the present disclosure provides a gate drive unit and a display device, in which a pull-up control module of the gate drive circuit of a current stage receives a gate control signal output from the gate drive circuit of a previous stage, so that a cascading module is omitted from the gate drive circuit, cascading control for the gate drive circuit of a plurality of stages may be realized, the number of transistors used in the gate drive circuit is reduced, and the layout space occupied by the gate drive circuit is reduced.

### BRIEF DESCRIPTION OF THE DRAWINGS

FIG. 1 is a schematic block diagram of a gate drive unit according to an embodiment of the present disclosure;

FIGS. 2A-2B is a schematic block diagram of a gate drive circuit according to an embodiment of the present disclosure;

FIG. 3 is a timing chart of a gate drive circuit according to an embodiment of the present disclosure;

FIGS. 4A-4B are simulation diagrams corresponding to a gate drive circuit according to an embodiment of the present disclosure;

FIG. 5 is a schematic block diagram of a display device according to an embodiment of the present disclosure.

### DETAILED DESCRIPTION

In order that the objectives, technical solutions, and effects of the present disclosure may be made clearer and more clarity. The present application is described in further detail hereinafter with reference to the accompanying drawings and by way of embodiments. It should be understood that specific embodiments described herein are for the purpose of explaining the present application only and are not intended to limit the present disclosure.

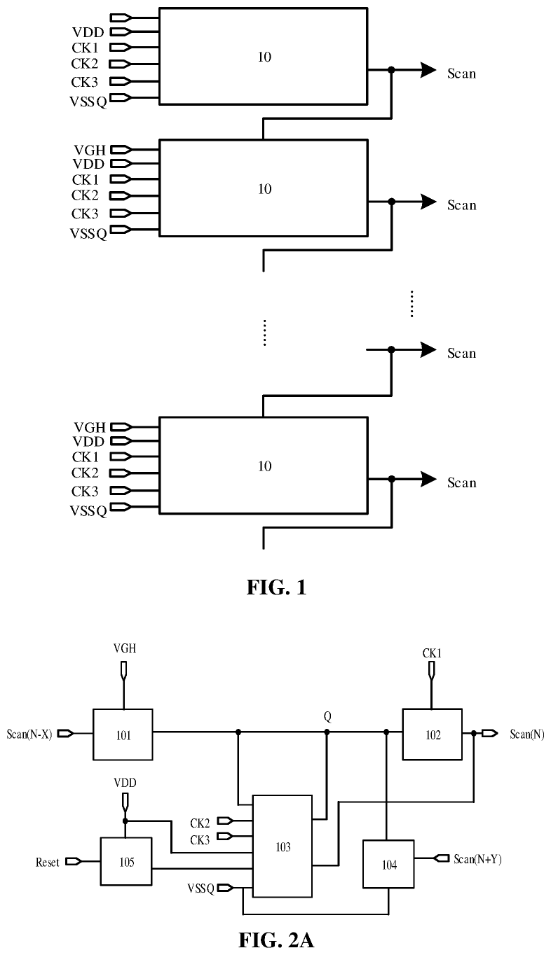

FIG. 1 is a schematic block diagram of a gate drive unit according to an embodiment of the present disclosure. The embodiment of the present disclosure provides a gate drive unit including a plurality of cascaded gate drive circuits 10 configured to generate a plurality of gate control signals Scan.

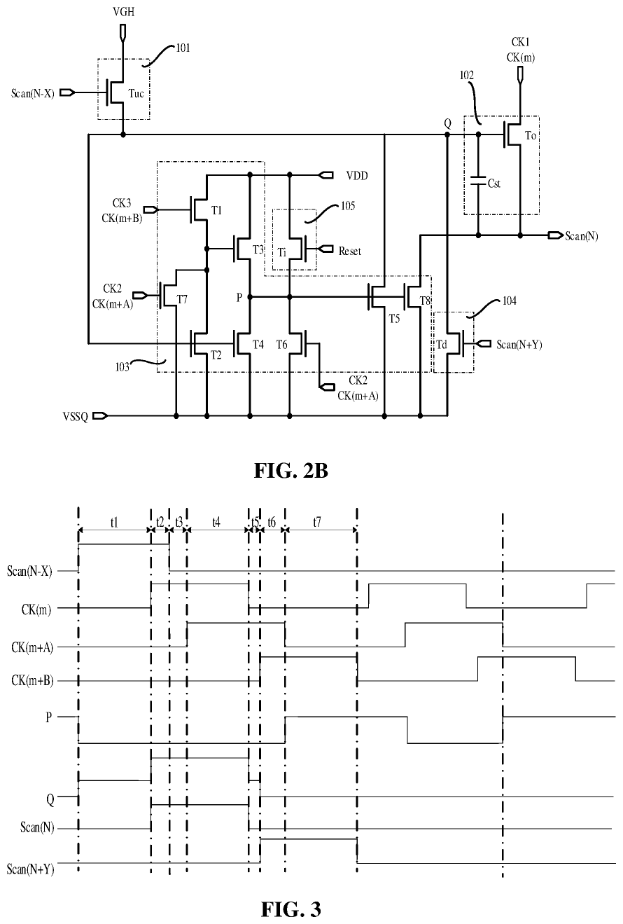

FIGS. 2A-2B is a schematic block diagram of a gate drive circuit according to an embodiment of the present disclosure. Each of at least one of the gate drive circuits 10 includes a pull-up control module 101, a pull-up module 102, a pull-down maintenance module 103, and a pull-down module 104.

The pull-up control module 101 is electrically connected to a first node Q. The pull-up control module 101 is configured to receive a gate control signal output from the gate drive circuit at a previous stage and transmit a first power supply signal VGH to the first node Q to raise a potential of the first node Q.

Alternatively, the pull-up control module 101 includes a pull-up control transistor Tuc. A control terminal of the pull-up control transistor Tuc is configured to receive the gate control signal output from the gate drive circuit at the previous stage. An input terminal of the pull-up control transistor Tuc is configured to receive the first power supply signal VGH. An output terminal of the pull-up control transistor Tuc is electrically connected to the first node Q. The pull-up control transistor Tuc is configured to transmit the first power supply signal VGH to the first node Q in accordance with the gate control signal output from the gate drive circuit of the previous stage to raise the potential of the first node Q.

Alternatively, the pull-up control module 101 at the N-th stage gate drive circuit receives a gate control signal Scan(N−X) output from the (N−X)-th stage gate drive circuit before the N-th stage gate drive circuit, to transmit the first power supply signal VGH to the first node Q of the Nth stage gate drive circuit according to the gate control signal Scan(N−X) output from the (N−X)-th stage gate drive circuit, so as to raise the potential of the first node Q in the Nth stage gate drive circuit. Where X>0.

Alternatively, the pull-up control module 101 in the first gate drive circuit of the gate drive circuits at a plurality of stages may receive an enable signal to transmit the first power supply signal VGH to the first node Q according to the enable signal to raise the potential of the first node Q in the first gate drive circuit.

With continued reference to FIGS. 2A-2B, the pull-up module 102 is electrically connected to the first node Q, and the pull-up module 102 is configured to transmit the first clock signal CK1 to a signal output terminal of the gate drive circuit 10 of the current stage according to the potential of the first node Q, and the signal output terminal is configured to output the gate control signal Scan.

Alternatively, the pull-up module 102 includes a pull-up transistor To and a storage capacitor Cst.

A control terminal of the pull-up transistor To is electrically connected to the first node Q. An input terminal of the pull-up transistor To is configured to receive the first clock signal CK1. An output terminal of the pull-up transistor To is electrically connected to the signal output terminal of the gate drive circuit 10 of the current stage. The pull-up transistor To is configured to be turned on or off according to the potential of the first node Q, to transmit the first clock signal CK1 to the signal output terminal of the gate driver circuit 10 of the current stage when the pull-up transistor To is turned on, so that the gate control signal Scan output from the signal output terminal of the gate driver circuit 10 of the current stage may have a active pulse.

The storage capacitor Cst is connected in series with and between the control terminal of the pull-up transistor To and the output terminal of the pull-up transistor To, and is configured to maintain the potential of the first node Q.

With continued reference to FIGS. 2A-2B, the pull-down maintenance module 103 is electrically connected to the first node Q. The pull-down maintenance module 103 is configured to transmit a second power supply signal VSSQ to the first node Q according to a second clock signal CK2 and a third clock signal CK3.

Alternatively, the pull-down maintenance module 103 includes a first transistor T1, a second transistor T2, a third transistor T3, a fourth transistor T4, a fifth transistor T5, and a sixth transistor T6.

A control terminal of the first transistor T1 is configured to receive the third clock signal CK3, and an input terminal of the first transistor T1 is configured to receive the third power supply signal VDD.

A control terminal of the second transistor T2 is electrically connected to the first node Q, an output terminal of the second transistor T2 is electrically connected to an output terminal of the first transistor T1, and an input terminal of the second transistor T2 is configured to receive the second power supply signal VSSQ.

A control terminal of the third transistor T3 is electrically connected to the output terminal of the first transistor T1, and an input terminal of the third transistor T3 is configured to receive the third power supply signal VDD.

A control terminal of the fourth transistor T4 is electrically connected to the first node Q, an input terminal of the fourth transistor T4 is configured to receive the second power supply signal VSSQ, and an output terminal of the fourth transistor T4 is electrically connected to an output terminal of the third transistor T3.

A control terminal of the fifth transistor T5 is electrically connected to an output terminal of the third transistor T3, an input terminal of the fifth transistor T5 is configured to receive the second power supply signal VSSQ, and an output terminal of the fifth transistor T5 is electrically connected to the first node Q.

A control terminal of the sixth transistor T6 is configured to receive the second clock signal CK2, an input terminal of the sixth transistor T6 is configured to receive the second power supply signal VSSQ, and an output terminal of the sixth transistor T6 is electrically connected to the control terminal of the fifth transistor T5.

Alternatively, the pull-down maintenance module 103 further comprises a seventh transistor T7. A control terminal of the seventh transistor T7 is configured to receive the second clock signal CK2, an input terminal of the seventh transistor T7 is configured to receive the second power supply signal VSSQ, an output terminal of the seventh transistor T7 is electrically connected to the control terminal of the third transistor T3. The seventh transistor T7 is configured to be turned on or off in response to the second clock signal CK2 to control the third transistor T3 to be turned off by the second power supply signal VSSQ when the seventh transistor T7 is turned on.

Alternatively, the pull-down maintenance module 103 further comprises an eighth transistor T8. A control terminal of the eighth transistor T8 is electrically connected to the control terminal of the fifth transistor T5, an input terminal of the eighth transistor T8 is configured to receive the second power supply signal VSSQ, and an output terminal of the eighth transistor T8 is electrically connected to the signal output terminal of the gate drive circuit of the current stage. The eighth transistor T8 is configured to be turned on synchronously with the fifth transistor T5 to pull down the potential of the signal output terminal of the gate drive circuit 10 through the second power supply signal VSSQ.

Referring again to FIGS. 2A and 2B, the pull-down module 104 is electrically connected to the first node Q, and the pull-down module 104 is configured to transmit the second power supply signal VSSQ to the first node Q according to a gate control signal output from a gate drive circuit of the next stage.

Alternatively, the pull-down module 104 includes a pull-down transistor Td. A control terminal of the pull-down transistor Td is configured to receive the gate control signal output from the gate drive circuit of the next stage. An input terminal of the pull-down transistor Td is configured to receive the second power supply signal VSSQ. An output terminal of the pull-down transistor Td is electrically connected to the signal output terminal of the gate drive circuit of the current stage. The pull-down transistor Td is configured to be turned on or off according to the gate control signal output from the gate drive circuit of the next stage, to transmit the second power supply signal VSSQ to the first node Q when the pull-down transistor Td is turned on, so as to pull down the potential of the first node Q.

Alternatively, the pull-down module of the Nth gate drive circuit receives the gate control signal Scan(N+Y) output from the (N+Y)th gate drive circuit after the Nth gate drive circuit, so that the pull-down module of the Nth gate drive circuit pulls a potential of the first node Q of the Nth gate drive circuit according to the gate control signal Scan(N+Y) output from the (N+Y)th gate drive circuit. Where Y>0.

Alternatively, the pull-up control module of the gate drive circuit of the Nth stage receives the gate control signal Scan (N−X) output from the (N−X)-th gate drive circuit before the Nth gate drive circuit. The pull-down module of the Nth gate drive circuit receives the gate control signal Scan(N+Y) output from the (N+Y)th gate drive circuit after the Nth gate drive circuit. Where Y>X. Therefore, the potential pull-up and potential pull-down of the first node Q of the Nth stage gate drive circuit are in an asymmetric form, so that the duration corresponding to the potential pull-down of the first node Q of the Nth stage gate drive circuit is less than the duration corresponding to the potential pull-up of the first node Q, thereby facilitating maintaining the potential stability of the first node Q.

Alternatively, the pull-up control module of the Nth gate drive circuit receives the gate control signal Scan(N−4) output from the (N−4)-th gate drive circuit before the Nth gate drive circuit, and the pull-down module of the Nth gate drive circuit receives the gate control signal Scan(N+6) output from the (N+6)-th gate drive circuit after the Nth gate drive circuit.

Alternatively, to save layout space and power consumption, the gate drive unit includes a plurality of stages of the gate drive circuit 10 that share M clock signals. Alternatively, X=M/2.

Alternatively, the gate drive unit further includes a reset module 105 configured to reset the potential of the first node Q according to the reset control signal Reset and the third power supply signal VDD. Alternatively, the reset module 105 is configured to reset the potential at the signal output terminal according to the reset control signal Reset and the third power supply signal VDD.

Alternatively, the reset module 105 includes a reset transistor Ti. A control terminal of the reset transistor Ti is configured to receive a reset control signal Reset. An input terminal of the reset transistor Ti is configured to receive the third power supply signal VDD. An output terminal of the reset transistor Ti is electrically connected to the control terminal of the fifth transistor T5. The reset transistor Ti is configured to be turned on or off according to the reset control signal Reset, to control the fifth transistor T5 and the eighth transistor T8 to be turned on by the third power supply signal VDD when the reset transistor Ti is turned on, to reset the potential of the first node Q and the potential of the signal output terminal by the second power supply signal VSSQ, and to remove residual charges at the first node Q and the signal output terminal.

Alternatively, the gate drive unit is applied to the display panel, and when the gate drive unit is turned on, the reset control signal Reset may be activated to have an active pulse to reset the potential of the first node in the gate drive circuits of the plurality of stages and the potential of the signal output terminal. Alternatively, the reset control signal Reset may have an active pulse during the blanking interval between adjacent frames to reset the potential of the first node in the gate drive circuits of the plurality of stages and the potential of the signal output terminal. The active pulse of the enable signal received by the first gate drive circuit in the gate drive circuits of the plurality of stages may be provided after the active pulse of the reset control signal Reset, so that each stage of the gate drive circuit may output a gate control signal Scan based on the same potential of the first node Q and the same potential of the signal output terminal, to improve uniformity of the gate control signals Scan output from the plurality of gate drive circuits.

Alternatively, the voltage value corresponding to the first power supply signal VGH is greater than the voltage value corresponding to the second power supply signal VSSQ.

Alternatively, to avoid a larger overlap (e.g., voltage overlap) between the transition of the potential of the first node Q in the gate drive circuit 10 from a high level to a low level and the transition of the potential of the second node P (i.e., the control terminal of the fifth transistor) from a low level to a high level, a starting time of the effective pulse of the second clock signal CK2 is behind a starting time of the effective pulse of the first clock signal CK1, a starting time of the effective pulse of the third clock signal CK3 is behind a starting time of the effective pulse of the second clock signal CK2, and the effective pulse of the third clock signal CK3 does not overlap the effective pulse of the first clock signal CK1.

Alternatively, the gate drive circuits 10 of the plurality of stages may share a plurality of clock signals in order to reduce layout space and power consumption. Accordingly, according to the stage number of each gate drive circuit 10, it is determined from the plurality of clock signals whether the clock signal used by said gate drive circuit 10 is the first clock signal CK1, the second clock signal CK2, or the third clock signal CK3.

Alternatively, if the gate drive circuits 10 of the plurality of stages shares M clock signals, the first clock signal CK1 received by the Nth stage gate drive circuit 10 is CK(m), the second clock signal CK2 received by the Nth stage gate drive circuit 10 is CK(m+A), and the third clock signal CK3 received by the Nth stage gate drive circuit 10 is CK(m+B). Where 0<m≤M, m<m+A≤M, m+A<m+B≤M, A>0, B>0; if N≤M, m=N; if N>M, m=N−aM, m>0, a>0, and a is an integer.

Alternatively, B=M/2, so that the active pulse of the third clock signal CK3 does not overlap the active pulse of the first clock signal CK1 (i.e., the third clock signal CK3 and the first clock signal CK1 are mutually coupled), so that the potential of the first node Q is pulled down after the gate control signal Scan output from the gate drive circuit 10 outputs the active pulse through the signal output terminal, thereby avoiding the influence on the gate control signal Scan output when the potential of the first node Q is pulled down.

Alternatively, the difference value between B and A may be a value selected from 1 to 3, so that there is no larger overlap (e.g., voltage overlap) between the transition of the potential of the first node Q in the gate drive circuit 10 from a high level to a low level and the transition of the potential of the second node P from a low level to a high level.

Alternatively, A is a value selected from 2, 3, or 4, etc., and B is a value selected from 4, 5, 6, 7, etc. Alternatively, A is a value of 2 and B is a value of 6, to improve the larger overlap (e.g., voltage overlap) between the transition of the potential of the first node Q in the gate drive circuit 10 from a high level to a low level and the transition of the potential of the second node P (i.e., the control terminal of the fifth transistor) from a low level to a high level, causing the charging of the first node Q to be affected and the occurrence of a larger current.

Alternatively, the values of A and B may be determined based on the received gate control signal of the previous stage and the received gate control signal of the next stage to reduce the complexity of signal selection. If the pull-up control module of the Nth stage gate drive circuit receives the gate control signal Scan (N−X), and the pull-down module of the Nth stage gate drive circuit receives the gate control signal Scan (N+Y), then B=X, A=Y−X.

Alternatively, at least one of the pull-up control transistor Tuc, the pull-up transistor To, the first transistor T1, the second transistor T2, the third transistor T3, the fourth transistor T4, the fifth transistor T5, the sixth transistor T6, the seventh transistor T7, the eighth transistor T8, the pull-down transistor Td, and the reset transistor Ti included in the gate drive circuit 10 may include a silicon transistor or an oxide transistor.

FIG. 3 is a timing chart corresponding to a gate drive circuit according to an embodiment of the present disclosure. Provided is an example in which the plurality of stages of the gate drive circuits 10 share twelve clock signals, the first clock signal CK1 received by the Nth stage gate drive circuit is CK(m), the second clock signal CK2 received by the Nth stage gate drive circuit is CK(m+A), the third clock signal CK3 received by the Nth stage gate drive circuit is CK(m+B), the gate control signal of the previous stage received by the Nth stage gate drive circuit is Scan(N−X), the gate control signal of the next stage received by the Nth stage gate drive circuit is Scan(N+Y), and each transistor included in the N-stage gate drive circuit is an N-type transistor. The operation principle of the N-stage gate drive circuit is described as follows:

Here, in the reset phase before the gate drive circuit 10 output the gate control signal Scan, the reset control signal Reset has the high level, and the reset transistor Ti in the gate drive circuit 10 is turned on, so that both the eighth transistor T8 and the fifth transistor T5 are turned on, so that the potential of the first node Q of the gate drive circuit 10 has the low level, and the potential of the second node P has the high level.

In the first stage t1, the gate control signal Scan (N−X) of the previous stage has the high level, and each of the first clock signal CK(m), the second clock signal CK(m+A), the third clock signal CK(m+B), and the next stage gate control signal Scan (N+Y) has the low level.

The pull-up control transistor Tuc is turned on, the first power supply signal VGH is transmitted to the first node Q via the pull-up control transistor Tuc to raise the potential of the first node Q, the second transistor T2, the fourth transistor T4, and the pull-up transistor To are turned on so that the potential of the second node P is pulled down, and the third transistor T3, the fifth transistor T5, and the eighth transistor T8 are turned off according to the second power supply signal VSSQ. The first clock signal CK1 is transmitted to the signal output terminal so that the gate control signal Scan(N) output from the signal output terminal has the low level.

In the second stage t2, each of the gate control signal Scan (N−X) of the previous stage and the first clock signal CK(m) has the high level, and each of the second clock signal CK(m+A), the third clock signal CK (m+B) and the lower gate control signal Scan (N+Y) has the low level.

The potential of the first node Q is further raised by coupling with the first clock signal CK(m) of the potential switching from the low level to the high level, so that the second transistor T2, the fourth transistor T4, and the pull-up transistor To are kept being turned on, and the third transistor T3, the fifth transistor T5, and the eighth transistor T8 are kept being turned off. The first clock signal CK1 is transmitted to the signal output terminal so that the gate control signal Scan(N) output from the signal output terminal has the high level.

In the third stage t3, the first clock signal CK(m) has the high level, and each of the gate control signal Scan(N−X) of the previous stage, the second clock signal CK(m+A), the third clock signal CK(m+B), and the gate control signal Scan(N+Y) of the next stage has the low level.

The storage capacitor Cst maintains the potential of the first node Q such that the second transistor T2, the fourth transistor T4, and the pull-up transistor To are kept on, and the third transistor T3, the fifth transistor T5, and the eighth transistor T8 are kept off. The first clock signal CK1 is transmitted to the signal output terminal so that the gate control signal Scan (N) output from the signal output terminal still has the high level.

In the fourth stage t4, each of the first clock signal CK(m) and the second clock signal CK(m+A) has the high level, and the gate control signal Scan(N−X) of the previous stage, the third clock signal CK(m+B) and the gate control signal Scan(N+Y) of the next stage has the low level.

The sixth transistor T6, the seventh transistor T7 are turned on according to the second clock signal CK (m+A), the storage capacitor Cst maintains the potential of the first node Q such that the third transistor T3, the fifth transistor T5, and the eighth transistor T8 are kept off according to the second power supply signal VSSQ, the second transistor T2, the fourth transistor T4, and the pull-up transistor To are kept on, and the first clock signal CK1 is transmitted to the signal output terminal such that the gate control signal Scan (N) output from the signal output terminal is kept at a high level.

In the fifth stage t5, the second clock signal CK(m+A) has the high level, and each of the gate control signal Scan(N−X) of the previous stage, the first clock signal CK(m), the third clock signal CK(m+B), and the gate control signal Scan(N+Y) of the low stage has the low level.

The sixth transistor T6 and the seventh transistor T7 are kept on, so that the third transistor T3, the fifth transistor T5 and the eighth transistor T8 are kept off according to the second power supply signal VSSQ. The potential of the first node Q is pulled down by coupling with the first clock signal CK(m) switching from the high level to the low level. Since the first clock signal CK1 has the low level, the gate control signal Scan(N) output from the signal output terminal has the low level.

In the sixth stage t6, each of the second clock signal CK(m+A) and the third clock signal CK(m+B) has a high level, and each of the gate control signals Scan(N+Y) of the next stage, and the gate control signals Scan (N−X) of the previous stage and the first clock signal CK(m) has a low level.

The pull-down transistor Td is turned on according to the gate control signals Scan(N+Y) of the next stage, so that the potential of the first node Q is further pulled down, and the second transistor T2, the fourth transistor T4, and the pull-up transistor To are turned off. The sixth transistor T6 and the seventh transistor T7 are turned on, the first transistor T1 is turned on according to the third clock signal CK(m+B), and the control terminal of the third transistor T3 responds to the third power supply signal VDD and the second power supply signal VSSQ. In some embodiments, if the voltage difference between the third power supply signal VDD and the second power supply signal VSSQ is less than the threshold voltage of the third transistor T3, the third transistor T3 remains turned off such that the potential of the second node P is kept at a low level by the second power supply signal VSSQ transmitted by the sixth transistor T6, and the fifth transistor T5 and the eighth transistor T8 remain turned off so as to reserve sufficient time for the potential of the first node Q to fall to the low level, to improve the greater overlapping of the voltage corresponding to the first node Q and the voltage corresponding to the second node P when the falling of the potential of the first node Q is delayed by the coupling capacitance and the potential of the second node P is in the rising phase.

In the seventh stage t7, the third clock signal CK(m+B) has the high level and the gate control signal Scan(N+Y) of the next stage, and the gate control signal Scan(N−X) of the previous stage, the second clock signal CK(m+A), and the first clock signal CK(m) are at the low levels.

The pull-down transistor Td is kept on so that the potential of the first node Q is kept at the low level, and the second transistor T2, the fourth transistor T4, and the pull-up transistor To are turned off. The first transistor T1 is kept on so that the third transistor T3, the fifth transistor T5, and the eighth transistor T8 are turned on, and the second power supply signal VSSQ is output to the signal output terminal so that the gate control signal Scan(N) output from the signal output terminal still has the low level.

Thereafter, the first clock signal CK(m), the second clock signal CK(m+A), and the third clock signal CK(m+B) have the switch between the low level and the high level, but are kept at the low level by the gate control signal Scan (N−X). Therefore, the potential of the first node Q may be affected by the first clock signal CK(m) in the actual application, and thus has a coupled switch at the switch of the first clock signal CK (m). The potential of the second node P will have the low-level due to the second clock signal CK(m+A), and have the high-level due to the third clock signal CK(m+B).

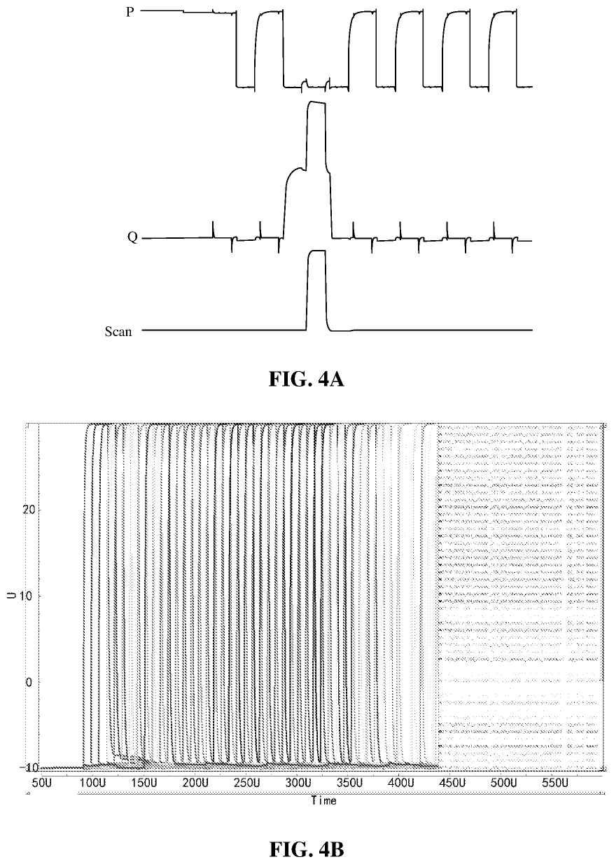

FIGS. 4A-4B is a simulation diagram corresponding to a gate drive circuit according to an embodiment of the present disclosure. Trust simulation is performed on the gate drive unit of the present disclosure in a high-temperature and high-humidity environment, and the obtained simulation waveform shows that a potential of a second node P of a single-stage gate drive circuit 10 switches between the high level to the low level, which meets design expectations. The potential variation of the first node Q meets the design expectation, and the gate control signal Scan output from the signal output terminal is normally output, so that the stability of the output of the gate drive circuit 10 may be maintained, as shown in FIG. 4A. The gate drive circuits 10 of the plurality of stages may implement a normal stage transmission function, and the gate drive circuits 10 of the plurality of stages may output the gate control signal Scan having the square pulse row-by-row, as shown in FIG. 4B. Therefore, the gate drive circuit 10 according to an embodiment of the present disclosure may realize an output function and a trust function similar to the conventional gate drive circuit 10 by using a less number of transistors. As an application embodiment of the present disclosure, the gate drive circuit 10 of the present disclosure has been applied to a 27-inch full HD resolution machine for verification, and the verification result is shown in the simulation result of FIGS. 4A-4B.

The gate drive circuit 10 according to an embodiment of the present disclosure reduces the number of transistors used in the single-stage gate drive circuit 10 by omitting the stage-transmission module so that the pull-up control unit of the gate drive circuit 10 is not controlled by a stage-transmission signal. The single-stage gate drive circuit 10 needs only no more than 12 transistors, thus may has stability and reliability same as the stability and reliability of the conventional gate drive circuit 10, thereby advantageously enabling the gate drive unit to satisfy the design requirements of the extremely narrow-bezel products, and to reduce the squeezing for the sub-pixel layout space by the gate drive circuit 10 when the gate drive unit is applied to the small-size display panels.

In the prior art, a gate drive circuit having a multi-stage output function (that is, gate control signals Scan of two or more stages are output from the same single-stage gate drive circuit 10) is used to reduce the number of gate drive circuits included in the gate drive unit so as to reduce the average number of transistors included in each gate drive circuit included in the gate drive unit. However, when the single-stage gate drive circuit outputs the gate control signals Scan of the plurality of stages, the overall load of the gate drive circuit and the gate drive unit is greater, and the size of each transistor needs to be increased to support the required performance requirements. Therefore, the power consumption of the gate drive circuit commonly outputting the gate control signals Scan of the plurality of stages is greater, and the layout space occupied by the gate drive circuit is increased to satisfy the stability and reliability requirements. Further, there is a stability problem in the gate drive circuit for simultaneously outputting the gate control signals Scan of the plurality of stages. To improve the stability problem, it is necessary to further introduce two power supply signals lower than the first power supply signal VGH for pulling down the potential of the first node and the signal output terminal. The stability and reliability of the gate drive circuit 10 may be maintained by applying only one power supply signal (i.e., the second power supply signal VSSQ) lower than the first power supply signal VGH.

Therefore, the gate drive circuit 10 according to an embodiment of the present disclosure has a lower power consumption than the gate drive circuit that outputs the gate control signals Scan of the plurality of stages at the same time. Therefore, the stability and reliability requirements may be satisfied without adjusting the transistor size while reducing the layout space occupied by the gate drive circuit 10; The number of applied signals is also less, which contributes to reducing the control difficulty.

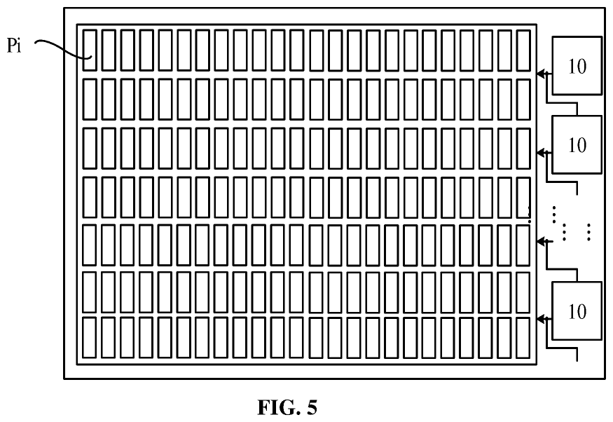

FIG. 5 is a schematic block diagram of a display device according to an embodiment of the present disclosure. The present disclosure further provides a display device including a gate drive unit and a plurality of sub-pixels Pi. Where the plurality of sub-pixels are electrically connected to the plurality of gate drive circuits 10.

Alternatively, the display device includes a passive light-emitting display device (such as a liquid crystal display device) and a spontaneous light-emitting display device (such as a display device including a light-emitting device such as an organic light-emitting diode, a sub-millimeter light-emitting diode, or a micro light-emitting diode).

Alternatively, the sub-pixel Pi includes a pixel drive circuit including at least one transistor, of which the control terminal receives a corresponding gate control signal Scan.

Alternatively, the pixel drive circuit may use a topology structure in the form of 2T1C (i.e., two transistors, one capacitor), 5T2C (i.e., five transistors, two capacitors), 7T1C (i.e., seven transistors, one capacitor), 8T2C (i.e., eight transistors, two capacitors), and the like.

The principles and embodiments of the present disclosure have been illustration with reference to specific examples, the description of the embodiments is merely intended to aid in the understanding of the method of the present disclosure and its core idea. At the same time, variations will occur to those skilled in the art in both the detailed description and the scope of application in accordance with the teachings of the present disclosure. In view of the foregoing, the present description should not be construed as limiting the application.

What is claimed is:

1. A gate drive unit comprises a plurality of cascaded gate drive circuits, wherein at least one of the gate drive circuits comprising:
a pull-up control module electrically connected to a first node and configured to receive a gate control signal output from the gate drive circuit of a previous stage and transmit a first power supply signal to the first node;
a pull-up module electrically connected to the first node and configured to transmit a first clock signal to a signal output terminal of the gate drive circuit of a current stage according to a potential of the first node;
a pull-down maintenance module electrically connected to the first node and configured to transmit a second power supply signal to the first node according to a second clock signal and a third clock signal; and
a pull-down module electrically connected to the first node and configured to transmit the second power supply signal to the first node according to a gate control signal output from the gate drive circuit of a next stage.

2. The gate drive unit of claim 1, wherein the pull-up control module comprises:
a pull-up control transistor, wherein a control terminal of the pull-up control transistor is configured to receive the gate control signal output from the gate drive circuit of the previous stage, an input terminal of the pull-up control transistor is configured to receive the first power supply signal, and an output terminal of the pull-up control transistor is electrically connected to the first node.

3. The gate drive unit of claim 1, wherein the pull-up module comprises:
a pull-up transistor, wherein a control terminal of the pull-up transistor is electrically connected to the first node, an input terminal of the pull-up transistor is configured to receive the first clock signal, and an output terminal of the pull-up transistor is electrically connected to the signal output terminal of the gate drive circuit of the current level; and
a storage capacitor connected in series with the control terminal of the pull-up transistor and the output terminal of the pull-up transistor.

4. The gate drive unit of claim 1, wherein the pull-down maintenance module comprises:
a first transistor having a control terminal configured to receive the third clock signal and an input terminal configured to receive a third power supply signal;
a second transistor having a control terminal electrically connected to the first node, an output terminal electrically connected to an output terminal of the first transistor, and an input terminal configured to receive the second power supply signal;
a third transistor having a control terminal electrically connected to the output terminal of the first transistor and an input terminal configured to receive the third power supply signal;
a fourth transistor having a control terminal electrically connected to the first node, an input terminal configured to receive the second power supply signal, and an output terminal electrically connected to an output terminal of the third transistor;
a fifth transistor having a control terminal electrically connected to the output terminal of the third transistor, an input terminal configured to receive the second power supply signal, and an output terminal electrically connected to the first node; and
a sixth transistor having a control terminal configured to receive the second clock signal, an input terminal configured to receive the second power supply signal, and an output terminal electrically connected to the control terminal of the fifth transistor.

5. The gate drive unit of claim 4, wherein the pull-down maintenance module further comprises:
a seventh transistor having a control terminal configured to receive the second clock signal, an input terminal configured to receive the second power supply signal, and an output terminal electrically connected to the control terminal of the third transistor.

6. The gate drive unit of claim 4, wherein the pull-down maintenance module further comprises:
an eighth transistor having a control terminal electrically connected to the control terminal of the fifth transistor, an input terminal configured to receive the second power supply signal, and an output terminal electrically connected to the signal output terminal of the gate drive circuit of the current level.

7. The gate drive unit of claim 4, further comprising a reset module, wherein the reset module comprises:
a reset transistor having a control terminal configured to receive a reset control signal, an input terminal configured to receive the third power supply signal, and an output terminal electrically connected to the control terminal of the fifth transistor.

8. The gate drive unit of claim 1, wherein the pull-down module comprises:
a pull-down transistor having a control terminal configured to receive the gate control signal output from the gate drive circuit of the next stage, an input terminal configured to receive the second power supply signal, and an output terminal configured to be electrically connected to the signal output terminal of the gate drive circuit of the current stage.

9. The gate drive unit of claim 1, wherein the pull-up control module of the gate drive circuit of an Nth stage receives the gate control signal output from the gate drive circuit of an (N−X)-th stage before the stage gate drive circuit of the Nth stage, and the pull-down module of the gate drive circuit of the Nth stage receives the gate control signal output from the gate drive circuit of an (N+Y)-th stage after the stage gate drive circuit of the Nth stage; and wherein Y>X, N>1, and X>0.

10. A display device, comprising:
a plurality of sub-pixels;
a gate drive unit comprising a plurality of cascaded gate drive circuits, wherein the plurality of sub-pixels are electrically connected to the plurality of gate drive circuits, and at least one of the gate drive circuits comprises:
a pull-up control module electrically connected to a first node and configured to receive a gate control signal output from the gate drive circuit of a previous stage and transmit a first power supply signal to the first node;
a pull-up module electrically connected to the first node and configured to transmit a first clock signal to a signal output terminal of the gate drive circuit of a current stage according to a potential of the first node;
a pull-down maintenance module electrically connected to the first node and configured to transmit a second power supply signal to the first node according to a second clock signal and a third clock signal; and
a pull-down module electrically connected to the first node and configured to transmit the second power supply signal to the first node according to a gate control signal output from the gate drive circuit of the next stage.

11. The display device of claim 10, wherein the pull-up control module comprises:
a pull-up control transistor, wherein a control terminal of the pull-up control transistor is configured to receive the gate control signal output from the gate drive circuit of the previous stage, an input terminal of the pull-up control transistor is configured to receive the first power supply signal, and an output terminal of the pull-up control transistor is electrically connected to the first node.

12. The display device of claim 10, wherein the pull-up module comprises:
a pull-up transistor, wherein a control terminal of the pull-up transistor is electrically connected to the first node, an input terminal of the pull-up transistor is configured to receive the first clock signal, and an output terminal of the pull-up transistor is electrically connected to the signal output terminal of the gate drive circuit of the current level; and
a storage capacitor connected in series with the control terminal of the pull-up transistor and the output terminal of the pull-up transistor.

13. The display device of claim 10, wherein the pull-down maintenance module comprises:
a first transistor having a control terminal configured to receive the third clock signal and an input terminal configured to receive a third power supply signal;
a second transistor having a control terminal electrically connected to the first node, an output terminal electrically connected to an output terminal of the first transistor, and an input terminal configured to receive the second power supply signal;
a third transistor having a control terminal electrically connected to the output terminal of the first transistor and an input terminal configured to receive the third power supply signal;
a fourth transistor having a control terminal electrically connected to the first node, an input terminal configured to receive the second power supply signal, and an output terminal electrically connected to an output terminal of the third transistor;
a fifth transistor having a control terminal electrically connected to the output terminal of the third transistor, an input terminal configured to receive the second power supply signal, and an output terminal electrically connected to the first node; and
a sixth transistor having a control terminal configured to receive the second clock signal, an input terminal configured to receive the second power supply signal, and an output terminal electrically connected to the control terminal of the fifth transistor.

14. The display device of claim 13, wherein the pull-down maintenance module further comprises:
a seventh transistor having a control terminal configured to receive the second clock signal, an input terminal configured to receive the second power supply signal, and an output terminal electrically connected to the control terminal of the third transistor.

15. The display device of claim 13, wherein the pull-down maintenance module further comprises:
an eighth transistor having a control terminal electrically connected to the control terminal of the fifth transistor, an input terminal configured to receive the second power supply signal, and an output terminal electrically connected to the signal output terminal of the gate drive circuit of the current level.

16. The display device of claim 13, further comprising a reset module, wherein the reset module comprises:
a reset transistor having a control terminal configured to receive a reset control signal, an input terminal configured to receive the third power supply signal, and an output terminal electrically connected to the control terminal of the fifth transistor.

17. The display device of claim 10, wherein the pull-down module comprises:
a pull-down transistor having a control terminal configured to receive the gate control signal output from the gate drive circuit of the next stage, an input terminal configured to receive the second power supply signal, and an output terminal configured to be electrically connected to the signal output terminal of the gate drive circuit of the current stage.

18. The display device of claim 10, the pull-up control module of the gate drive circuit of an Nth stage receives the gate control signal output from the gate drive circuit of an (N−X)-th stage before the stage gate drive circuit of the Nth stage, and the pull-down module of the gate drive circuit of the Nth stage receives the gate control signal output from the gate drive circuit of an (N+Y)-th stage after the stage gate drive circuit of the Nth stage; and wherein Y>X, N>1, and X>0.
